(19) United States
(12) Patent Application Publication
(10) Pub. No.: US 2006/0237637 A1
(43) Pub. Date: Oct. 26, 2006

(54) Motor-encoder system having a flexible coupling

(76) Inventors: Reinhard Beatty, Blacksburg, VA (US); Thomas Keith Bunch, Pulaski, VA (US)

Correspondence Address: MORGAN & FINNEGAN, L.L.P., 3 World Financial Center, New York, NY, 10281-2101, US

(21) Appl. No.: 11/114,972

(22) Filed: Apr. 25, 2005

(51) Int. Cl. G01D 5/34

(52) U.S. Cl. 250/231.14

(57) ABSTRACT

A motor system having a motor and an encoder is built using a metal bellows coupling for anti-rotation of encoder housing with high torsional stiffness and capacity to survive large radial and axial misalignment (both static and dynamic) in a very compact space.

### FIELD OF THE INVENTION

This invention relates to a motor system having a motor, an encoder and a flexible coupling. More particularly, the present invention relates to the flexible coupling having a provision by which the stators of the motor and the encoder are connected.

### BACKGROUND OF THE INVENTION

The basic components of a motor generally include a rotor that spins inside a housing (i.e., a stator) that does not move. The rotor spins in the electromagnetic field contained in the stator. A shaft is generally connected to the spinning rotor thereby transferring the rotational movement to a load connected to the shaft. A motor system usually includes an encoder (or resolver) to control the operation of the motor system. The encoder is connected to the motor system to provide the position and speed information of the rotor of the motor system. This information may be used by a user to control the operation of the motor system using, for example, an external motor controller with associated electronics.

Housed rotary optical encoders are the most common type of encoders used in a motor system to provide the rotary position of the motor. A housed rotary optical encoder typically includes a housing (i.e., a stator) to support precision bearings and a shaft with an optical disk attached thereto. The shaft of the rotary optical encoder is usually rigidly coupled to the shaft of the motor to detect the rotational position of the motor.

A flexible stator coupling is used in the housed rotary optical encoder to prevent rotation of the encoder housing with respect to the motor housing while allowing radial and axial misalignment, both static and dynamic. Despite its flexibility in the radial and axial directions, the coupling must have high torsional stiffness in order to prevent undesirable dynamic positioning errors from the encoder.

Couplings for the purpose of joining housed encoders and motors are commercially available which are stiff torsionally. While these couplings have been quite successful in a majority of applications, they experience fatigue failures in certain applications that require a large amount of radial and axial misalignment.

Bellows couplings have been used for connection of encoder and motor stators which are formed from elastomeric materials, however these are not suitable for certain applications which require high positional accuracy, both static and dynamic. Metal bellows couplings have also been used to couple encoder shaft to motor shaft, whereby the motor and encoder stators are rigidly coupled. In this arrangement, the coupling diameter is small since it is mounted to the shaft, therefore the torsional stiffness is lower and the positional errors in operation are higher. The smaller diameter of the shaft-coupling also allows a lesser amount of radial and axial misalignment.

### SUMMARY OF THE INVENTION

The above-identified problems are solved and a technical advance is achieved in the art by providing a method and system that connects the motor and the encoder with a flexible coupling thereby achieving a high torsional stiffness in the motor system, along with obtaining capacity for handling larger amounts of radial and axial misalignment without experiencing fatigue damage.

In accordance with an aspect of the invention, there is provided a bellows coupling that connects the housing of a motor (i.e., motor stator) and the housing of an encoder (i.e., encoder stator).

In accordance with another aspect of the invention, there is provided a motor system comprising a motor, having a shaft and a housing, capable of driving a load connected to the shaft of the motor; an encoder, having a shaft and a housing, capable of detecting the rotational position of the shaft of the motor; a flexible coupling capable of connecting the housing of the motor to the housing of the encoder, wherein the shaft of the motor and the shaft of the encoder are connected with a rigid connection.

Other and further aspects of the present invention will become apparent during the course of the following detailed description and by reference to the attached drawings.

### BRIEF DESCRIPTION OF THE DRAWINGS

FIG. 1 illustrates simplified diagram of the motor system including a motor, an encoder and a stacked type flexible coupling of the present invention;

FIGS. 2A, 2B, 2C, 2D illustrate an embodiment of the flexible coupling of the present invention;

FIG. 3 is a graph showing the test result of the torsional resonance of the motor system of the present invention;

FIG. 4 illustrates four accelerometers located on the surface of the encoder of the motor system; and

FIG. 5 illustrates simplified diagram of the motor system including a motor, an encoder and a concentric type flexible coupling of the present invention.

### DETAILED DESCRIPTION

One aspect of the present invention is directed to the connection between a motor and encoder. In particular, a flexible bellows coupling is used to connect the encoder housing (i.e., encoder stator) with the motor housing (i.e., motor stator) in a motor system. It is assumed that the shaft of the motor and the encoder are rigidly connected.

In the present invention, the convolutions of the bellows coupling can be oriented in two ways, i.e., stacked and concentric. In the stacked embodiment, the convolutions are stacked one on top of another. In the concentric embodiment, the convolutions are in concentric layers outward from a central axis.

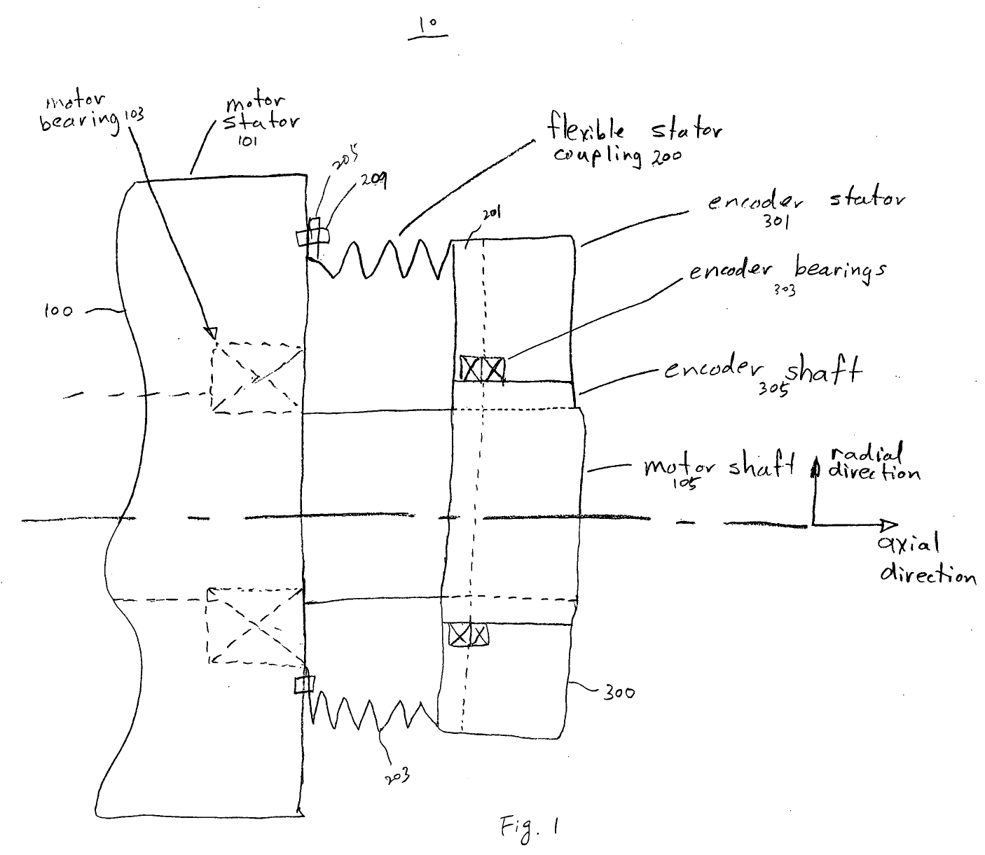

FIG. 1 illustrates a simplified diagram of the motor system 10 of the present invention showing a stacked type flexible stator coupling 200 that connects a motor 100 and an encoder 300 of the present invention. The motor includes a motor stator 101, a motor bearing 103 and a motor shaft 105. The encoder includes encoder stator 301, encoder bearings 303 and an encoder shaft 305. In this embodiment, a bolt/nut type connection is used between the flexible coupling and the motor, and a sleeve type connection is used between the flexible coupling and the encoder.

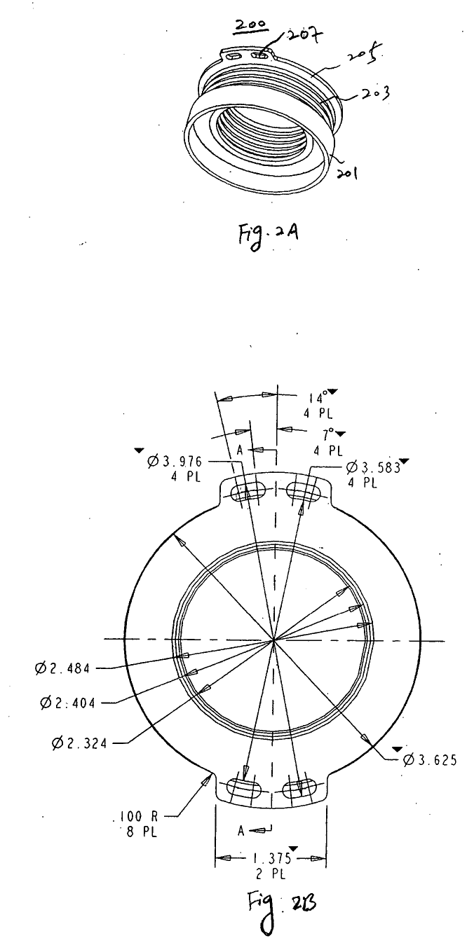

FIGS. 2A, 2B, 2C, 2D illustrate an embodiment of the flexible coupling of the present invention that can be used to connect the motor and encoder as shown in FIG. 1. Referring to FIG. 2A, the flexible coupling of the present invention includes three main parts, i.e., a first part 201 having a sleeve, a second part 203 having a bellows and a third part 205 having a flange. The third part also includes holes 207 through which bolts may be used. Referring back to FIG. 1, the sleeve of the first part of the flexible coupling is configured to receive the outer surface of the encoder stator 301 and the flange of the third part of the flexible coupling is configured to attach to the side surface of the motor stator 101. In this embodiment, the flexible coupling of the present invention is a bellows coupling and made of stainless steel (e.g., 321SS). Alternatively, other materials may be used which meet the criteria for high torsional stiffness and capacity for high misalignment for the bellows coupling.

FIGS. 2B, 2C, 2D illustrate the dimensions of the flexible coupling of the present invention in this embodiment. In particular, FIG. 2B illustrates the dimensions of the flexible coupling when viewed from the flange of the third part 205. FIG. 2C is a cross-sectional view of the flexible coupling when cut along the line A-A as indicated in FIG. 2B. FIG. 2D illustrates an exploded view of a portion of the flexible coupling as indicated A in FIG. 2C.

Referring to FIG. 2B, exemplary dimensions of the flexible coupling include the outer diameter (3.625″) and the inner diameter (2.324″). Additionally, the material thickness of the flexible coupling is 0.008 inches in this embodiment.

Table I shows working conditions during the movement of the flexible coupling.

TABLE 1
Working Conditions During Operation

| | |
|---|---|
| Temperature Max. | 150° C., 302 F. |
| Torsional Stiffness (±30%) | 36,076 Nm/rad |
| Material Thickness | 0.20 mm, 0.008 in |
| Plies | 1 |
| Convolutions | 4 |
| Fatigue Life | Infinite |
| Dynamic Radial Offset | ±0.14 mm, ±0.0055 in |
| Operating Torque | 0.42 Nm, 60.0 ozin |
| Static Radial Offset | ±0.24 mm, ±0.0095 in |
| Static Axial Offset | ±0.76 mm, ±0.030 in |

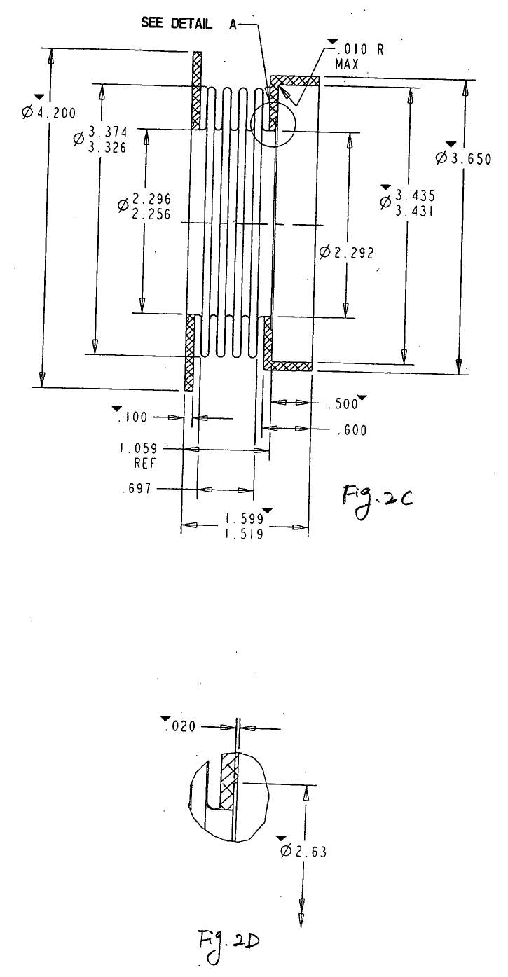

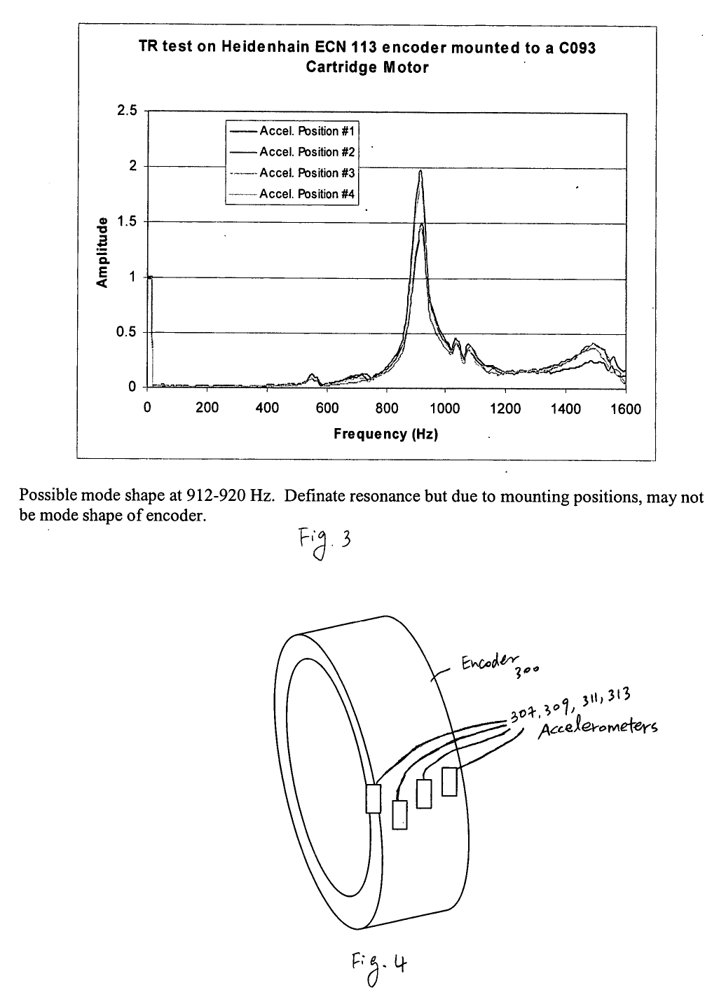

An experiment has been performed to test the flexible coupling built according to the embodiment as described above. The motor system embodying the present invention shows nearly the same frequency of torsional resonance as the flexible coupling previously used. FIG. 3 illustrates torsional resonance test results in a motor system built according to the present invention showing the amplitude values varying depending on the frequency. The amplitude values are measured by several accelerometers 307, 309, 311, 313 located on the surface of the encoder of the motor system as shown in FIG. 4. The result shows that a possible mode shape occurs at the frequency range between 912-920 Hz, nearly identical to the other non-bellows style of coupling.

A second experiment was performed to verify the life of the bellows coupling when operated under combined radial and axial misalignment. The bellows coupling survived 113 million cycles under a 0.009 inches radial misalignment in combination with 0.012 inches radial run-out with no degradation or damage. The original non-bellows coupling was tested in a similar manner under lower levels of offset (0.004 inches radial runout) and failed due to fatigue crack propagation after as little as 4 million cycles.

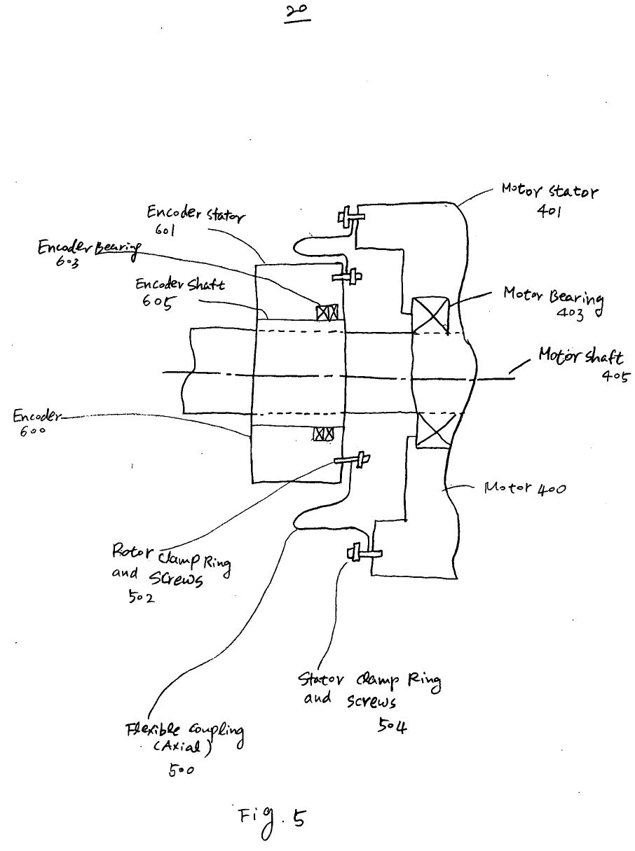

FIG. 5 illustrates a simplified diagram of the motor system 20 of the present invention showing a concentric type flexible stator coupling 500 that connects a motor 400 and an encoder 600 of the present invention as an alternative embodiment. The motor includes a motor stator 401, a motor bearing 403 and a motor shaft 405. The encoder includes encoder stator 601, encoder bearings 603 and an encoder shaft 605. The flexible coupling in this embodiment is now concentric instead of stacked. While FIG. 5 shows a concentric flexible coupling having one convolution, two or more convolutions may be used as well within the scope of the present invention.

Although illustrative embodiments of the present invention have been described in detail herein with reference to the accompanying drawings, it is to be understood that the invention is not limited to these embodiments, and that various changes and further modifications may be effected therein by one skilled in the art without departing from the scope or spirit of the invention, which is defined in the claims, below. For an example, while the flexible coupling of the present invention connects the motor stator and the encoder stator having a similar diameter, this invention may also be applied easily to the motor stator and encoder stator having different diameter without significant modification. Additionally, while the flexible coupling of the present invention uses a flange type connection and a bolt/nut type connection, other types of connections may be used as well within the scope of the invention.

What is claimed is:

1. A motor system comprising:
a motor, having a shaft and a housing, capable of driving a load connected to the shaft of the motor;
an encoder, having a shaft and a housing, capable of detecting the rotational position of the shaft of the motor, wherein the shaft of the encoder is rigidly connected to the shaft of the motor; and
a flexible bellows coupling configured to connect the housing of the motor to the housing of the encoder.

2. The motor system according to claim 1, wherein the flexible coupling is made of thin-walled metal.

3. The motor system according to claim 1, wherein the flexible coupling is made of a stainless steel.

4. The motor system according to claim 1, wherein the flexible coupling is a stacked type.

5. The motor system according to claim 1, wherein the flexible coupling is a concentric type.

6. A flexible bellows coupling device configured to be connected to the stator of a motor at a first end and configured to be connected to stator of an encoder at a second end, thereby coupling the motor and the encoder.

7. The bellows coupling device according to claim 6, wherein the flexible bellows coupling is a stacked type where convolutions are stacked one on top of another.

8. The bellows coupling device according to claim 6, wherein the flexible bellows coupling is a concentric type where convolutions are in concentric layers outward from a central axis.
